(19) United States
(12) Patent Application Publication
(10) Pub. No.: US 2009/0194266 A1
(43) Pub. Date: Aug. 6, 2009

(54) STRAIGHT TUBE HEAT EXCHANGER WITH EXPANSION JOINT

(76) Inventors: Joachim CONRAD, Neukirchen (DE); Kay Degner, Munchen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/360,887

(22) Filed: Jan. 28, 2009

(30) Foreign Application Priority Data
Jan. 29, 2008 (DE) 102008006559.5

(51) Int. Cl. F28D 7/00; B23P 15/26

(52) U.S. Cl. 165/165; 29/890.054

(57) ABSTRACT

The invention involves a straight tube heat exchanger 1 with a shell 2, a tube bundle 3 (for the sake of clarity, only two tubes of the tube bundle 3 are shown), two opposite manifolds 4a, 4b, means for introducing and discharging 5a, 5b the first medium into and from the tube space, and means for introducing and discharging the second medium into and from the shell space 6a, 6b, as well as a single-pass expansion joint 7, as it is used, for example, as a preheater in synthesis gas production unit. Both the shell 2 and the two manifolds 4a, 4b are made from heat-resistant, creep-resistant steel, especially a chromium-molybdenum alloy. The expansion joint 7 are made from chromium-nickel steel just like the two welding-ring seals 8. By the expansion joint being made from chromium-nickel steel, the different mechanical stresses are completely absorbed by the high temperature. In the production, the two manifolds 4a, 4b as well as the shell 2 made from two partial pieces 2a, 2b are provided with an overlay welding and conveyed into an annealing process. After the annealing process, the manifolds 4a, 4b and the two shell pieces 2a, 2b are connected via the overlay welding to the corresponding chromium-nickel steel parts (welding-ring seal 8, expansion joint 7). The manifolds 4a, 4b are flange-mounted on the shell 2.

### BACKGROUND OF THE INVENTION

The invention relates to a heat exchanger with a straight tube bundle, as described in the preamble of claim 1. The invention, in general, is described in terms of a heat exchanger with a straight tube bundle, as it is used in an apparatus for the production of synthesis gas. However, the invention is not limited to use in a synthesis gas apparatus. The heat exchanger in accordance with the invention can be used, in principle, for heat exchange between any two media, and each medium, independently of the other medium, can be present either in liquid or gaseous form.

In a synthesis gas apparatus, in most cases synthesis gas is produced from a fossil fuel by means of thermal cracking. The resultant synthesis gas produced in this case is present at a higher temperature than is required for most applications. To cool the hot synthesis gas, mainly heat exchangers with a longitudinally extended, straight tube bundle are used, according to the prior art. In these so-called straight tube heat exchangers, for example, feed water, which is to be preheated for other applications, enters into heat exchange with the hot synthesis gas. In such a heat exchanger with a longitudinally extended, straight tube bundle, one medium is conveyed into the tube space for the heat exchange, while the second medium is conveyed into the shell space, which encloses the tube space. The tube space of such a heat exchanger essentially consists of two manifolds with mounted supports, which are suitable for feeding and removing the first heat exchange medium, and a longitudinally extended, straight tube bundle, having at least two tubes. The shell space encloses the tube space and has at least one feed inlet and at least one discharge outlet for the heat exchange second medium. The shell space is sealed relative to the tube space.

The synthesis gas can be conveyed either into the tube space and into the shell space in co-current flow or countercurrent flow to the feed water. Usually, the hot synthesis gas is conveyed into the tube space and water is conveyed into the shell space in a heat exchanger of the synthesis gas apparatus. In the case of a synthesis gas apparatus, the two media involved in the heat exchange typically have a very high temperature difference. The heat exchanger is manufactured at room temperature. In a preheater in a synthesis gas apparatus, hot synthesis gas is introduced into the heat exchanger at a temperature of, for example, between 300° C. and 450° C. and conveyed in co-current or counter-current flow to water or feed gas at room temperature. The different heat expansions between tube and shell space caused by this temperature difference result in mechanical stresses. According to the prior art, such mechanical stresses can be absorbed by an expansion joint. An expansion joint is generally designed as a corrugated structure having at least one wave in one or more layers. Due its corrugated structure, the expansion joint is able to readily take up different mechanical expansions at fixed ends. Similar to an accordion, the expansion joint can be pressed together or stretched out. According to the prior art, such an expansion joint can be either incorporated into the shell, or a straight tube heat exchanger with a floating head is used, as in the German patent application “Wärmetauscher mit geradem Rohrbündel und Schwimmkopf [Heat Exchanger with Straight Tube Bundle and Floating Head]” (file number 102007017227.5) assigned to Linde AG.

As materials for the production of a straight tube heat exchanger, many various types of steel or aluminum alloys are suitable depending on the planned use, the pressures and temperatures that are produced therefrom, and the media that take an active part in the heat exchange. When employed as a preheater in a synthesis gas apparatus, the heat exchanger is generally made of heat-resistant, creep-resistant steel, preferably a chromium-molybdenum alloy or chromium-nickel steel. Chromium-nickel steel is considerably more expensive than heat-resistant, creep-resistant steel and therefore is not to be preferred for economic reasons. On the other hand, in the production of a heat exchanger made from creep-resistant steel, the parts are produced in a heat-shaping process or in the welded manner, which requires a subsequent annealing to reduce production of corresponding mechanical stresses. Such an annealing process, however, cannot be performed with an expansion joint in the shell because the expansion joint would lose elasticity due to the annealing process. Therefore, an expansion joint has to be produced from chromium-nickel steel. According to the prior art, the entire heat exchanger is thus produced from chromium-nickel steel. A similar problem also arises in sealing the manifolds from the shell space.

### SUMMARY OF THE INVENTION

One aspect of the invention is to configure a heat exchanger of the type such that the economic efficiency of its production is improved without it resulting in an increase of the thermal stresses during use and thus in a reduction of the service life.

In accordance with the invention, the shell and expansion joint are made from different materials and are connected by means of an overlay welding, and/or the manifolds are sealed, relative to the shell space, by means of a welding-ring seal, wherein the welding-ring seal is made of a material that is different from that of the manifolds and/or that of the shell, and is connected via an overlay welding to the respective parts.

The heat exchanger according to the invention is made from various parts of different materials, and the materials used to make the various parts can be optimized according to standpoints of technical use and economy. Different parts of a heat exchanger have to meet different mechanical or thermal requirements. An expansion joint in the shell, for example, has to be heat-resistant and elastic enough to accommodate mechanical deformations. The remaining part of the shell, however, only has to be heat-resistant, since it transfers its mechanical stresses to the expansion joint. In terms of the invention, the materials of the different parts of a heat exchanger are matched to these different requirements and conditions of use. The parts made from different materials are connected to one another according to the invention by means of an overlay welding. An overlay welding is a means, known to and tested by one skilled in the art, for connecting metal parts of components made of different materials.

According to a preferred configuration of the invention, the shell and/or the manifolds are made from a heat-resistant, creep-resistant steel, preferably a chromium-molybdenum alloy, and the expansion joint and/or the welding-ring seal are made from chromium-nickel steel. Heat-resistant, creep-resistant steels, in particular chromium-molybdenum alloys, have proven advantageous for use in high temperature heat exchangers. Chromium-nickel steel also has high heat resistance, as well as very good elastic properties. In this configuration of the invention, the majority of the shell can be advantageously made of heat-resistant, creep-resistant steel, while only those parts in the heat exchanger having higher requirements of elastic behavior are made from the more expensive chromium-nickel steel. An optimum matching of the parts of the heat exchanger to the different requirements is thus provided.

Advantageously, the overlay welding is made from a nickel- and/or molybdenum-based alloy, preferably Incoloy 825 (a nickel-iron-chromium alloy containing molybdenum and copper). An overlay welding made from a nickel- and/or molybdenum-based alloy, preferably Incoloy 825, is a suitable means for connecting different metal materials, especially a heat-resistant, creep-resistant steel and chromium-nickel steel.

The invention also relates to a process for the production of a straight tube heat exchanger according to the invention. According to the invention, two parts of different materials are to be connected by means of an overlay welding. At least one part is provided with the overlay welding. The part with the overlay welding is conveyed into an annealing process and then connected to the other part via the overlay welding.

According to an especially preferred configuration of the invention, the shell pieces and/or manifolds made from heat-resistant, creep-resistant steel are provided with an overlay welding, conveyed into an annealing process, and then welded via the overlay welding with parts made from chromium-nickel steel, such as an expansion joint and/or welding-ring seal. By the annealing process, mechanical stresses, which are necessarily created in the production of parts from heat-resistant, creep-resistant steel, are reduced in these parts, thereby considerably increasing their service life. The overlay welding is not influenced by the annealing process and makes possible a reliable connection between parts made from heat-resistant, creep-resistant steel and parts made from chromium-nickel steel.

Advantageously, a straight tube heat exchanger in accordance with the invention is used in a synthesis gas apparatus or hydrogen production plant, preferably as preheaters for cooling hot synthesis gas while simultaneously heating water.

With this invention, it is possible in particular to optimally match different parts of a heat exchanger to their different mechanical and thermal requirements. The economic efficiency of the production of such a heat exchanger is considerably increased, without accompanying losses of mechanical or thermal stability.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 illustrates an embodiment of a heat exchanger according to the Invention;

FIG. 2 illustrates a detailed drawing of the connection between the shell and expansion joint; and

FIG. 3 illustrates a detailed drawing of the connection between welding-ring seal and manifold.

### DETAILED DESCRIPTION OF THE DRAWINGS

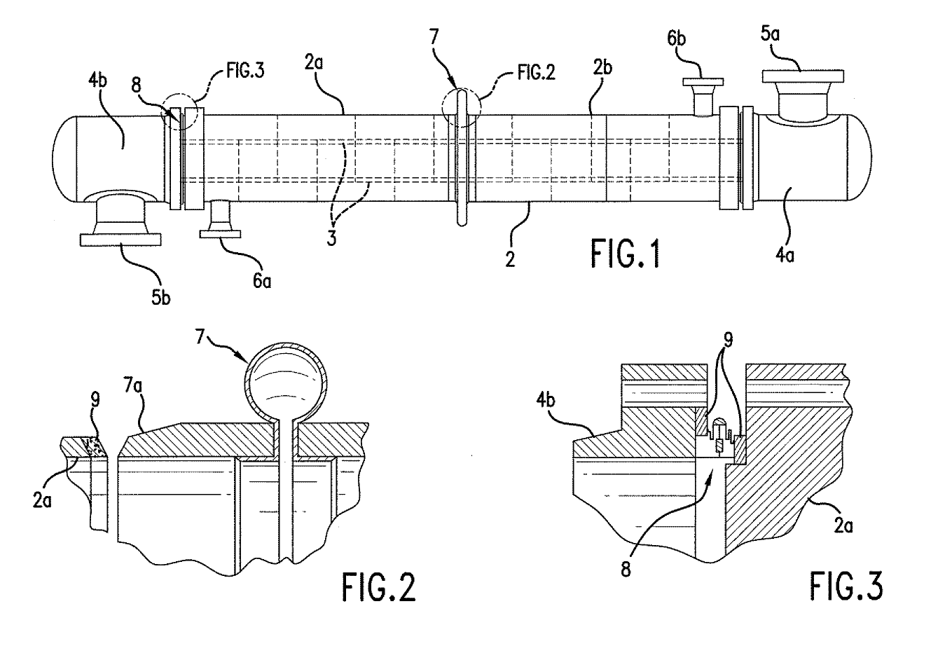

FIG. 1 shows an embodiment of a straight tube heat exchanger 1 according to the invention with a shell 2, a tube bundle 3 (for the sake of clarity, only two tubes of the tube bundle 3 are shown), two opposite manifolds 4a, 4b, means for introducing and discharging the first medium into and from the tube space 5a, 5b, and means for introducing and discharging the second medium into and from the shell space 6a, 6b, as well as a single-pass expansion joint 7. Such a heat exchanger can be used, for example, as a preheater in a synthesis gas production unit. In this embodiment, the hot synthesis gas is conveyed at a temperature of 450° C. via the introduction means 5a and the distribution manifold 4a into the tubes of the tube bundle 3. Cooled synthesis gas leaves the heat exchanger at a temperature of approximately 320° C. via the collection manifold 4b and the discharge means 5b. The synthesis gas is cooled by water flowing in counter-current in shell space 2. The introduction and discharge of water into and from the shell space is carried out via the introduction and discharge means 6a or 6b, respectively. Both the shell 2 and the two manifolds 4a, 4b are made from heat-resistant, creep-resistant steel, preferably a chromium-molybdenum alloy. The expansion joint 7 is made from chromium-nickel steel, as are the two welding-ring seals 8. By manufacturing the expansion joint 7 from chromium-nickel steel, the different mechanical stresses that result from the high temperature synthesis gas are completely absorbed. In the production, the two manifolds 4a, 4b, as well as the shell 2 made from two partial pieces 2a, 2b, are provided with an overlay welding and conveyed into an annealing process. After the annealing process, the precombustion chambers 4a, 4b and the two shell pieces 2a, 2b are connected via the overlay welding to the corresponding chromium-nickel steel parts (welding-ring seal 8, expansion joint 7). The precombustion chambers 4a, 4b are flange-mounted on the shell 2.

FIG. 2 shows the detailed representation of the connection of the expansion joint 7 to the shell part 2a. The shell part 2a has an overlay welding 9. The expansion joint 7 with a correspondingly short shell-like connecting piece 7a is made from chromium-nickel steel and is connected via the overlay welding 9 to the shell part 2a made from a chromium-molybdenum alloy.

FIG. 3 shows the detailed representation of the connection of the manifold 4b to the welding-ring seal 8 and the shell piece 2a. Both the manifold 4b and the shell piece 2a are each made from a chromium-molybdenum alloy and are connected via the overlay welding 9 to the welding-ring seal 8 that consists of chromium-nickel steel.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding German application No. 102008006559.5, filed Jan. 29, 2008.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A straight tube heat exchanger (1) for heat exchange between two media in the liquid and/or gaseous phase comprising:
a) A tube bundle (3) for conveying a medium,
b) A shell space (2) enclosing the tube bundle (3) for conveying the second medium,
c) Two opposite manifolds (4a, 4b) with means for introducing and discharging a the first medium in or from the tube bundle, whereby the manifolds (4a, 4b) are fastened to the shell (2),
d) Means for introducing and discharging the first medium (5a, 5b) in the manifolds as well as means for introducing and discharging the second medium in the shell space (6a, 6b), as well as
e) At least one expansion joint (7) in the shell (2), which is at least one-pass,
wherein said shell (2) and expansion joint (7) are made from different materials and are connected by means of an overlay welding (9)
and/or
said manifolds (4a, 4b) are sealed by means of a welding-ring seal (8) relative to the shell space (2), and said welding-ring seal (8) is made from a material that is different from that of said manifolds (4a, 4b) and/or said shell (2).

2. A straight tube heat exchanger (1) according to claim 1, wherein the shell (2) and/or the manifolds (4a, 4b) are made from a heat-resistant, creep-resistant steel.

3. A straight tube heat exchanger (1) according to claim 1, wherein the expansion joint (7) and/or the welding-ring seal (8) are made from chromium-nickel steel.

4. A straight-tube heat exchanger (1) according to claim 1, wherein the overlay welding (9) is made from a nickel and/or molybdenum-based alloy.

5. A process for the production of a straight tube heat exchanger (1) according to claim 1, wherein two parts of the heat exchanger, made of different materials, are to be connected by means of an overlay welding (9), the process comprising:
providing at least one part with said overlay welding (9),
conveying the part with said overlay welding (9) into an annealing process, and
then connecting part with said overlay welding to the other of said two parts via said overlay welding (9).

6. A process for the production of a straight tube heat according to claim 5, wherein the shell pieces (2a, 2b) and/or manifolds (4a, 4b) made from heat-resistant, creep-resistant steel are provided with said overlay welding (9), are conveyed into an annealing process, and then are welded via said overlay welding (9) with the respective parts made from chromium-nickel steel.

7. A method of cooling the hot synthesis gas comprising:
introducing hot synthesis gas into either the shell or the tubes of a straight tube heat exchanger (1) according to claim 1,
introducing a cooling medium such as water into the other of said shell or said tubes of said heat exchanger, and
performing heat exchange by flowing said synthesis gas and said cooling medium within said heat exchanger in co-current or counter-current flow, thereby cooling said hot synthesis gas while simultaneously heating said cooling medium.

8. A straight tube heat exchanger (1) according to claim 2, wherein the shell (2) and/or the manifolds (4a, 4b) are made from a chromium-molybdenum alloy.

9. A straight tube heat exchanger (1) according to claim 2, wherein the expansion joint (7) and/or the welding-ring seal (8) are made from chromium-nickel steel.

10. A straight-tube heat exchanger (1) according to claim 2, wherein the overlay welding (9) is made from a nickel and/or molybdenum-based alloy.

11. A straight-tube heat exchanger (1) according to claim 3, wherein the overlay welding (9) is made from a nickel and/or molybdenum-based alloy.

12. A straight-tube heat exchanger (1) according to claim 1, wherein the overlay welding (9) is made from Incoloy 825.

13. A process for the production of a straight tube heat exchanger (1) according to claim 2, wherein two parts of the heat exchanger, made of different materials, are to be connected by means of an overlay welding (9), the process comprising:
providing at least one part with said overlay welding (9),
conveying the part with said overlay welding (9) into an annealing process, and
then connecting part with said overlay welding to the other of said two parts via said overlay welding (9).

14. A process for the production of a straight tube heat exchanger (1) according to claim 3, wherein two parts of the heat exchanger, made of different materials, are to be connected by means of an overlay welding (9), the process comprising:
providing at least one part with said overlay welding (9),
conveying the part with said overlay welding (9) into an annealing process, and
then connecting part with said overlay welding to the other of said two parts via said overlay welding (9).

15. A process for the production of a straight tube heat exchanger (1) according to claim 4, wherein two parts of the heat exchanger, made of different materials, are to be connected by means of an overlay welding (9), the process comprising:
providing at least one part with said overlay welding (9),
conveying the part with said overlay welding (9) into an annealing process, and
then connecting part with said overlay welding to the other of said two parts via said overlay welding (9).

16. A straight tube heat exchanger (1) for heat exchange between two media in the liquid and/or gaseous phase, said heat exchanger comprising:
a tube bundle (3) for conveying a first medium;
a shell space (2) enclosing said tube bundle (3) for conveying a second medium;
two opposite manifolds (4a, 4b) fastened to the shell (2), one of said manifolds being provided with means for introducing said first medium into said tube bundle, and the other of said manifolds being provided with discharge means for removing said first medium from said tube bundle;
means for introducing said second medium into said shell space (6a), and means for discharging said second medium from said shell space (6b); and
at least one expansion joint (7) in said shell (2), which is at least one-pass,
wherein said shell (2) and expansion joint (7) are made from different materials and are connected by means of an overlay welding (9)
and/or
said manifolds (4a, 4b) are sealed by means of a welding-ring seal (8) relative to the shell space (2), and said welding-ring seal (8) is made from a material that is different from that of said manifolds (4a, 4b) and/or said shell (2).
